(19) United States
(12) Patent Application Publication
(10) Pub. No.: US 2010/0232188 A1
(43) Pub. Date: Sep. 16, 2010

(54) POWER SUPPLY APPARATUS

(75) Inventor: Minoru Hayasaki, Mishima-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/721,478

(22) Filed: Mar. 10, 2010

(30) Foreign Application Priority Data
Mar. 13, 2009 (JP) 2009-061110

(51) Int. Cl. H02M 3/335

(52) U.S. Cl. 363/21.15

(57) ABSTRACT

In a power supply apparatus, a current limitation unit configured to detect a current flowing through a primary winding of a transformer to limit a current to a switching unit has a self-holding unit configured to self-hold a state where the current to the switching unit is limited.

### BACKGROUND OF THE INVENTION

1. Field of the Invention

The present invention relates to a power supply apparatus, and more particularly, to a reduction in a period of time consumed to turn off a switching element.

2. Description of the Related Art

FIG. 7 illustrates an example of a circuit diagram of a conventional self-excited flyback power supply as a first conventional example. The operations of the self-excited flyback power supply will be described below. In FIG. 7, an alternating voltage input from a commercial alternating current (AC) power source 700 is converted into a direct current (DC) voltage by a rectifying circuit 702 and a smoothing capacitor 703 via a filter circuit 701. A primary winding Np of a transformer 704 and a switching element 706 are connected in series. A start resistor 705 is connected between the positive terminal of the capacitor 703 and the gate of the switching element 706. An auxiliary winding Nb is surrounded on the primary side of the transformer 704. A resistor 710 is provided between the gate and the source of the switching element 706. A gate resistor 709 is provided on the side of the gate of the switching element 706. A current flows from the auxiliary winding Nb into resistors 709 and 710 via a resistor 707 and capacitor 708.

When a current flows through the start resistor 705 by a DC voltage of the capacitor 703 so that a gate voltage of the switching element 706 rises, a drain current flows, and a current flows through the primary winding Np. As a result, the transformer 704 is excited so that a voltage is induced in the auxiliary winding Nb. Therefore, the gate voltage of the switching element 706 rises, so that the switching element 706 is turned on. On the other hand, the voltage of the auxiliary winding Nb is also supplied to a time constant circuit including a resistor 711 and a capacitor 712. A voltage across the capacitor 712 is also applied between the base and the emitter of a transistor 713.

When the voltage across the capacitor 712 rises so that the transistor 713 is turned on, a current flows via the resistor 709. Therefore, the gate voltage of the switching element 706 drops, so that the switching element 706 is turned off. A resistor 715 and diode 716 are provided for discharging the capacitor 712.

When the switching element 706 is turned off, a terminal voltage of the secondary winding Ns of the transformer 704 is reversed. Therefore, a current flows out of the secondary winding Ns via a secondary rectifier diode 721. This current charges a capacitor 722.

The capacitor 722 is charged with energy stored in the transformer 704 while the energy is restricted by the inductance of the secondary winding Ns. A drain voltage of the switching element 706 in a period during which the switching element 706 is turned off is the sum of a voltage, which is obtained by multiplying the voltage of the secondary winding Ns by the ratio of the number of turns of the primary winding Np to the number of turns of the secondary winding Ns, and a voltage with which the capacitor 703 is charged.

When the current in the secondary winding Ns becomes zero, a voltage that has been generated at the drain of the switching element 706 starts to vibrate in a period determined by the inductance of the secondary winding Ns and a capacitor 726, centered at a voltage with which the capacitor 703 is charged.

The voltage of the primary winding Np is reflected on the auxiliary winding Nb. When the drain voltage of the switching element 706 becomes lower than a voltage across the capacitor 703, a voltage is applied to the winding Nb so that the gate voltage of the switching element 706 is higher than that of the source thereof. When the voltage exceeds a gate threshold voltage of the switching element 706, the switching element 706 is turned on again, to repeat a series of operations, described above.

When a voltage across the capacitor 722 rises, a shunt regulator 725 is operated by the voltage divided by the resistors 723 and 724, and a current flows through a photocoupler PC101 via the resistor. A photodiode in the photocoupler PC101 lights up, so that the impedance of a phototransistor in the photocoupler PC101 is lowered.

As a result, the voltage across the capacitor 712 in the time constant circuit rises earlier than when the capacitor 712 is charged via the resistor 711. Therefore, the transistor 713 is turned on, and the switching element 706 is turned off. A switching power supply outputs a predetermined voltage by such a feedback operation.

FIG. 7 also illustrates an example of a circuit for turning off the switching element 706 on the primary side by current detection on the primary side. Both ends of a resistor 717 are respectively connected to the base of a transistor 718 and a current detection resistor 720. The switching element 706 is turned on so that a drain current flows through the switching element 706. Therefore, the voltage of the current detection resistor 720 rises. When a base-to-emitter voltage of the transistor 718 rises to approximately 0.6 volts, a base current in the transistor 718 rapidly increases.

A current, which is Hfe times the base current in the transistor 718, flows through the collector of the transistor 718, to discharge the charge at the gate thereof. Thus, the gate voltage of the switching element 706 drops so that the switching element 706 is turned off.

A current limitation circuit (the resistor 720 and the transistor 718) in the switching element 706 in the power supply apparatus in the first conventional example could be used without any issue when the capacitance of the power supply is small, and a capacitance between the gate and the source of the switching element 706 and a capacitance between the gate and the drain thereof are small. When output power of the power supply is increased and the current of the switching element 706 is increased, the capacitance between the gate and the source and the capacitance between the gate and the drain are large. Therefore, it is difficult to quickly set the gate voltage to the gate threshold voltage or less.

More specifically, a period of time consumed to turn the switching element 706 off (i.e., a turn-off time) is long, and the switching element 706 limits a current before being completely turned off so that the detection value of the current detection resistor 720 is decreased. When the detection value of the current detection resistor 720 is decreased, the base current in the transistor 718 also decreases. Therefore, the transistor 718 does not flow a current for lowering the gate voltage, and the turn-off time becomes longer.

In order to solve this issue, Japanese Patent No. 0370743 proposes a circuit whose current gain is increased by connecting transistors in a plurality of stages. FIG. 8 illustrates this circuit as a second conventional example.

As illustrated in FIG. 8, the circuit has a Darlington configuration in which transistors in two stages are connected. A current obtained by amplifying a base current in a transistor 815 at a gain, which is Hfe1 of a transistor 815 in the first stage times Hfe2 of a transistor 817 in the second stage, is caused to flow out of the gate of a switching element 804. This enables the amount of a gate current flowing out of the gate of the switching element 804 to be made larger than that when the number of transistors is one, thereby enabling the switching element 804 to be turned off at high speed. In addition, the circuit has a transformer 802, a start resistor 803, resistors 805, 806, 807, 810, 812, 814, 816, and 823, capacitors 808 and 811, a transistor 813, diodes 818, 820, 822, and 824, and electrolytic capacitors 801 and 821.

However, a current flowing out of the gate of the circuit, i.e., a collector current Ic2 in the transistor 817 in the second stage satisfies Ic2=Hfe1×Hfe2×(Vr−Vbe)/R, which depends on a detection voltage, where R is the resistance value of a resistor 814, and Vr is a voltage across a current detection resistor 806. Vr is the product of a drain current Id in the switching element 804 and the resistance value of the resistor 806. Vbe is a base-to-emitter voltage of the transistor 815.

When a current in the current detection resistor 806 decreases, the base current in the transistor 815 decreases, and the collector current in the transistor 817 also decreases. When the gate capacitance of the switching element 804 is large, a period of time consumed to turn off the switching element 804 is lengthened in a method discussed in Japanese Patent No. 03707436.

### SUMMARY OF THE INVENTION

According to an aspect of the present invention, a power supply apparatus includes a transformer, a switching unit configured to control a current flowing through a primary winding of the transformer, a current detection unit configured to detect a current flowing through the primary winding, a voltage output unit connected to a secondary winding of the transformer, an ON-time control unit connected to an auxiliary winding of the transformer and configured to control a period of time to turn on the switching unit, and a current limitation unit configured to limit a current to flow to the switching unit based on the detected current, in which the current limitation unit has a self-holding unit configured to self-hold a state where the current to the switching unit is limited.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a circuit diagram illustrating a configuration according to a first exemplary embodiment.

FIG. 2 illustrates a self-holding circuit.

FIG. 3 illustrates a waveform of each unit in the first exemplary embodiment.

FIG. 4 illustrates the waveform of each unit in a conventional example.

FIG. 5 is a circuit diagram illustrating a configuration according to a second exemplary embodiment.

FIG. 6 is a circuit diagram illustrating a configuration according to a third exemplary embodiment.

FIG. 7 is a circuit diagram illustrating a configuration in a first conventional example.

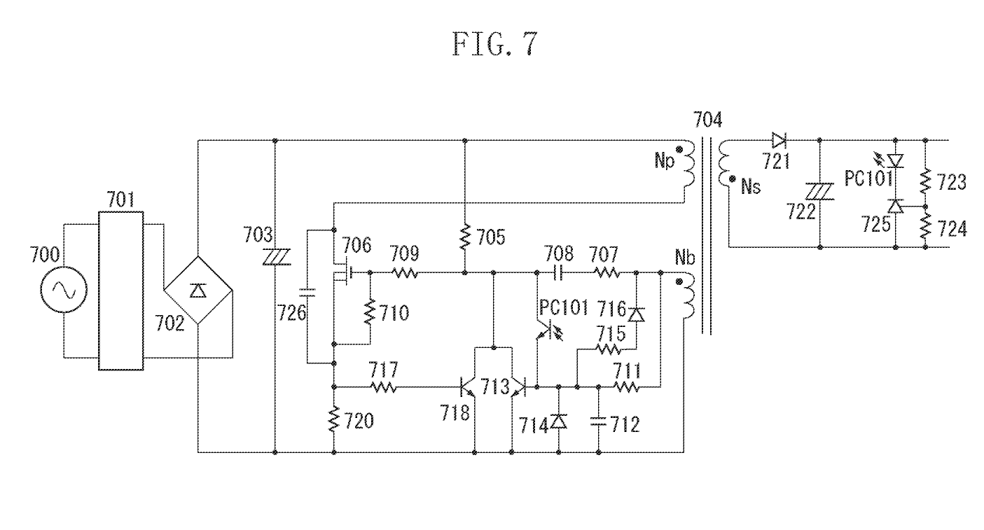

FIG. 8 is a circuit diagram illustrating a configuration according to a second conventional example.

### DESCRIPTION OF THE EMBODIMENTS

Various exemplary embodiments, features, and aspects of the invention will be described in detail below with reference to the drawings. It is to be noted that the relative arrangement of the components, the numerical expressions, and numerical values set forth in these embodiments are not intended to limit the scope of the present invention.

Exemplary embodiments for carrying out the present invention will be described in more detail by taking a switching power supply apparatus of a self-excited oscillation type as an example. First, a switching power supply apparatus of a self-excited oscillation type according to a first exemplary embodiment will be described.

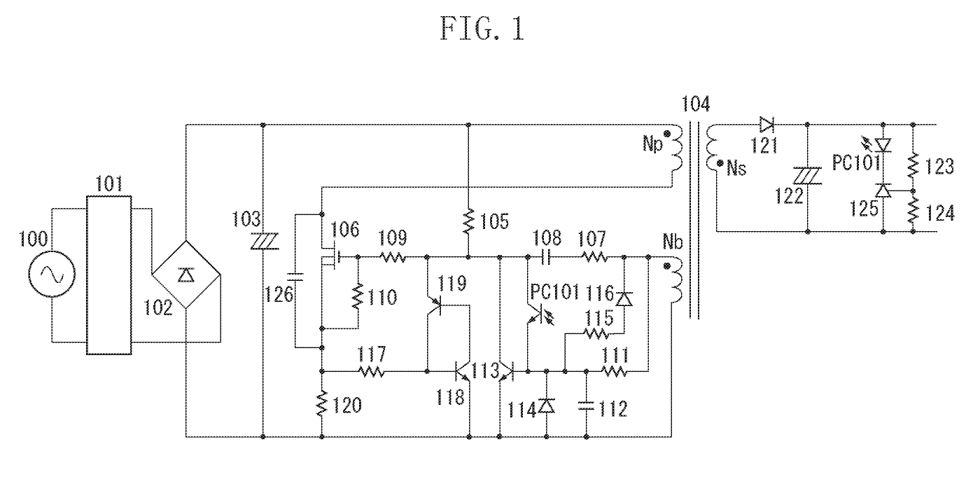

FIG. 1 is a circuit diagram of a switching power supply apparatus of a self-excited oscillation type according to the present exemplary embodiment. In FIG. 1, the switching power supply apparatus includes a commercial AC power source 100, a filter circuit 101, a diode bridge 102, an electrolytic capacitor 103, a switching transformer 104, a primary winding Np of the transformer 104, a secondary winding Ns of the transformer 104, and a bias winding (feedback winding or auxiliary winding) Nb of the transformer 104, a start resistor 105, a switching element (field effect transistor (FET)) 106, resistors 107, 109, and 110, and a capacitor 108.

The switching power supply apparatus further includes resistors 111, 115, 117, 120, 123, and 124, NPN transistors 113 and 118, and a PNP transistor 119. The transistor 118 and the transistor 119 constitute a self-holding circuit. The details of the self-holding circuit will be described below. The switching power supply apparatus further includes capacitors 112 and 126, diodes 114 and 116, a secondary rectifier diode 121, an electrolytic capacitor 122, a shunt regulator 125, and a photocoupler PC101, which correspond to an output circuit.

In the circuit according to the present exemplary embodiment, the resistor 111 and the capacitor 112 constitute a time constant circuit. The respective operations of the time constant circuit and the photocoupler PC101 are similar to those in the conventional example and hence, the description thereof is not repeated.

When a voltage is applied to the diode bridge 102 from the commercial AC power source 100 via the filter circuit 101, the diode bridge 102 full-wave-rectifies the voltage, to peak-charge the electrolytic capacitor 103. Therefore, a DC voltage is generated across the electrolytic capacitor 103.

In other words, the diode bridge 102 and the electrolytic capacitor 103 constitute a DC power source. The DC voltage generated across the electrolytic capacitor 103 is divided by the start resistor 105, the gate resistor 109, and the resistor 110. A voltage appearing in the resistor 110 is also applied between the gate and the source of the switching element 106. When the voltage exceeds a gate threshold value of the switching element 106, the switching element 106 is turned on.

When the switching element 106 is turned on, a current flows from the electrolytic capacitor 103 via a series circuit of the primary winding Np of the transformer 104, the drain to the source of the switching element 106, and the resistor 120. In each of the windings other than the primary winding Np of the transformer 104, a voltage corresponding to a voltage applied to the primary winding Np and the ratio of the number of turns of the winding to the number of turns of the primary winding Np is generated.

In the secondary winding Ns, a voltage, which is lower at its terminal connected to the anode of the diode 12 and higher at the opposite terminal, is generated. Therefore, the diode 121 is reverse-biased so that only a leakage current flows therethrough. In the bias winding Nb, a voltage at its terminal connected to the cathode of the diode 116 becomes high. Therefore, a current is caused to flow to the resistors 109 and 110 via the resistor 107 and the capacitor 108.

Therefore, a gate-to-source voltage of the switching element 106 further rises so that the on-resistance of the switching element 106 is lowered. When the switching element 106 is turned on, a current flowing through the transformer 104 increases with time, and the voltage of the current detection resistor 120 serving as a current detection element also rises. The voltage of the current detection resistor 120 rises so that a base current starts to flow through the transistor 118. More specifically, when a current detected by the current detection resistor 120 exceeds a predetermined value, the base current flows through the transistor 118.

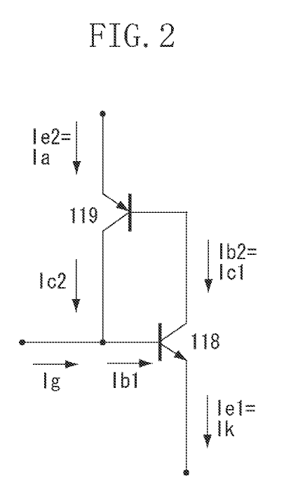

FIG. 2 illustrates the self-holding circuit including the transistor 118 and the transistor 119.

The transistor 118 attempts to cause a collector current, which is Hfe1 times the base current flowing through the base thereof, to flow through the collector thereof, wherein the Hfe1 is the current gain of the transistor 118. The collector current in the transistor 118 causes a base current to flow through the base of the transistor 119. The transistor 119 also causes a collector current, which is Hfe2 times the base current, to flow, wherein the Hfe2 is the current gain of the transistor 119.

Therefore, a current flows from the emitter of the transistor 119 to the collector thereof so that the base current in the transistor 118 rises and the collector current in the transistor 118 further rises. Even if a drain current flowing through the drain of the switching element 106 decreases so that the voltage of the current detection resistor 120 drops, the base current in the transistor 118 does not decrease because it is supplied by the transistor 119.

Therefore, the transistors 118 and 119 continue to be turned on without being affected by the drain current. This state is a state where a current limitation operating state is self-held. A gate voltage of the switching element 106 attempts to drop to a base-emitter saturation voltage of each of the transistors 118 and 119 upon being discharged by the transistor.

When the switching element 106 is turned off, a voltage is generated in each of the windings of the transformer 704, and a current flows from the secondary winding Ns via the secondary rectifier diode 121, to charge the capacitor 122. A drain voltage of the switching element 106 in a period during which the switching element 106 is turned off is the sum of a voltage, which is obtained by multiplying the voltage of the secondary winding Ns by the ratio of the number of turns of the primary winding Np to the number of turns of the secondary winding Ns, and a voltage with which the electrolytic capacitor 103 is charged.

When the current in the secondary winding Ns becomes zero, a voltage that has been generated at the drain of the switching element 106 starts to vibrate in a period determined by the inductance of the primary winding Np and the capacitor 126, centered at the voltage with which the electrolytic capacitor 103 is charged.

The voltage of the winding Ns is reflected on the winding Nb. Therefore, a voltage on the side of the resistor 107 of the winding Nb becomes lower than a voltage at the anode of the diode 114 in a period during which the capacitor 122 is being charged. Therefore, the charge on the capacitor 112 is discharged via the resistor 115 and the diode 116.

The gate voltage of the switching element 106 decreases to zero volts. At this time, an emitter current flowing through the emitter of the transistor 119 in the self-holding circuit including the transistors 118 and 119 decreases, and a current flowing into the base of the transistor 118 from the current detection resistor 120 becomes zero. Therefore, a self-holding operation is stopped, so that the transistors 118 and 119 are turned off.

When the switching element 106 is turned on, to perform a current limiting operation, as described above, the self-holding circuit including the transistors 118 and 119 performs the self-holding operation, to fix the transistors to an ON state while turning the switching element 106 off.

When the switching element 106 is turned off, the gate voltage of the switching element 106 becomes zero volts, and a current in the self-holding circuit becomes zero, so that the self-holding circuit is turned off. This operation is repeated, to enable a current detecting operation to be performed for each switching of the switching element 106.

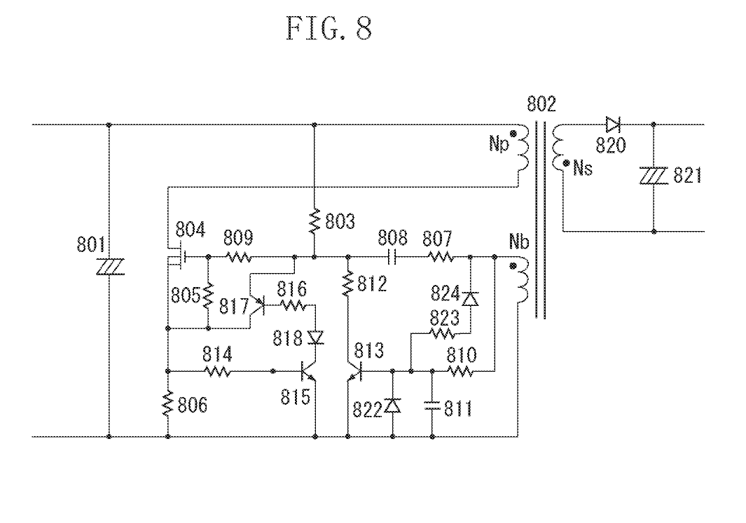

A current limitation circuit using the self-holding circuit according to the present exemplary embodiment will be described, by comparing with the current limitation circuit having the Darlington configuration in the power supply apparatus illustrated in FIG. 8 in the second conventional example.

A drain current Id in the switching element 106 can be expressed by the following equation (1), where gm is the gain of the switching element 106, Vg is the gate voltage of the switching element 106, and Vgs is a gate threshold voltage of the switching element 106:

Id=gm(Vg−Vgs) (1)

If the equation (1) is differentiated, the following equation (2) is obtained:

$$\frac{d I d}{d t} = gm \frac{Vg}{d t} \qquad ( 2 )$$

In FIG. 8, the gate charge Qg on the switching element 804 is expressed by the following equation (3), where Cg is the gate capacitance of the switching element 804 and Vg is the gate voltage of the switching element 804:

Qg=Cg×Vg (3)

The gate charge Qg is discharged by a collector current Ic817 in the transistor 817:

Qg=−∫Ic817dt (4)

When the equation (4) is differentiated, and the equation (3) is substituted in the equation (4), the following equation (5) is obtained:

$$\frac{d Vg}{d t} = - \frac{Ic 817}{Cg} \qquad ( 5 )$$

The Darlington configuration is constituted by the transistors 815 and 817 as illustrated in FIG. 8. Where Hfe1 and Hfe2 are the current gains of the transistors 815 and 817, respectively, the collector current Ic817 in the transistor 817 is expressed by the following equation (6):

Ic817=Hfe1×Hfe2×(Id×R806−Vbe)/R814 (6)

Here, R814 is the resistance value of the resistor 814, R806 is the resistance value of the resistor 806, and Vbe is the base-to-emitter voltage of the transistor 815.

The rate of change in the drain current Id in the switching element 804 can be expressed by the following equations (7) from the equations (2), (5), and (6):

$$\frac{d I d}{d t} = - \frac{gm \times Hfe 1 \times Hf e 2 ( Id \times R 806 - Vbe )}{Cg \times R 814} \qquad ( 7 )$$

The rate of change in the drain current depends on the drain current. When the switching element 804 starts to be turned off, the drain current Id in the switching element 804 decreases. When the drain current decreases so that the voltage across the resistor 806 decreases to a value closer to the base-to-emitter voltage of the transistor 815, the rate of change in the drain current in the switching element 804 becomes zero, so that the drain current does not decrease. A period of time consumed to turn off the switching element 804 is lengthened by such a negative feedback operation.

On the other hand, the self-holding circuit according to the present exemplary embodiment will be described. FIG. 2 illustrates the self-holding circuit including the transistors 118 and 119. FIG. 2 is also an equivalent circuit diagram of a thyristor.

As illustrated in FIG. 2, when an anode current in the self-holding circuit including the transistors 118 and 119, which is considered as the thyristor, is expressed by Ia, the anode current is an emitter current in the transistor 119, so that Ie2=Ia. Similarly, a cathode current Ik in the self-holding circuit, which is considered as the thyristor, is an emitter current in the transistor 118, so that Ie1=Ik. When a gate current is expressed by Ig, the following equations (8), (9), (10), and (11) are obtained:

Qg=−∫Iadt (8)

Ia=Vg/Rg (9)

Qg=Cg×Vg (10)

Id=gm(Vg−Vgs) (11)

From the foregoing equations, the following equation (12) is obtained:

$$\frac{d I d}{d t} = - \frac{Id + gm \times Vg}{Cg \times R 117} \qquad ( 12 )$$

The rate of change in the drain current in the switching element 106 also depends on Id. Even if Id=0, however, the rate of change does not reach zero. Therefore, the drain current in the switching element 106 continues to decrease.

As described above, in the self-holding circuit according to the present exemplary embodiment, the effect of negative feedback with the decrease in the drain current in the switching element 106 can be reduced. This enables a period of time during which the gate voltage of the switching element 106 is maintained to be shortened, enabling a period of time consumed to turn off the switching element 106 to be shortened.

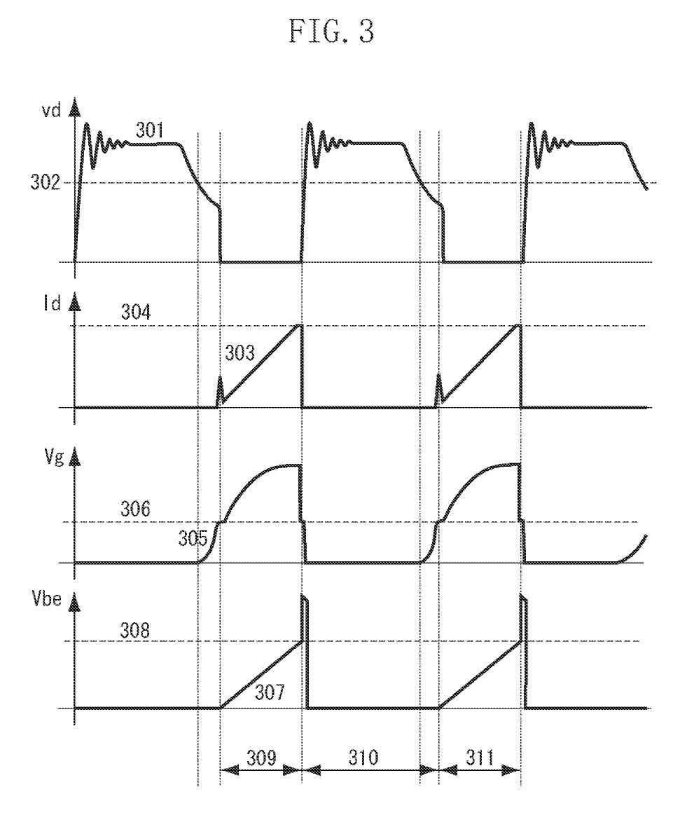

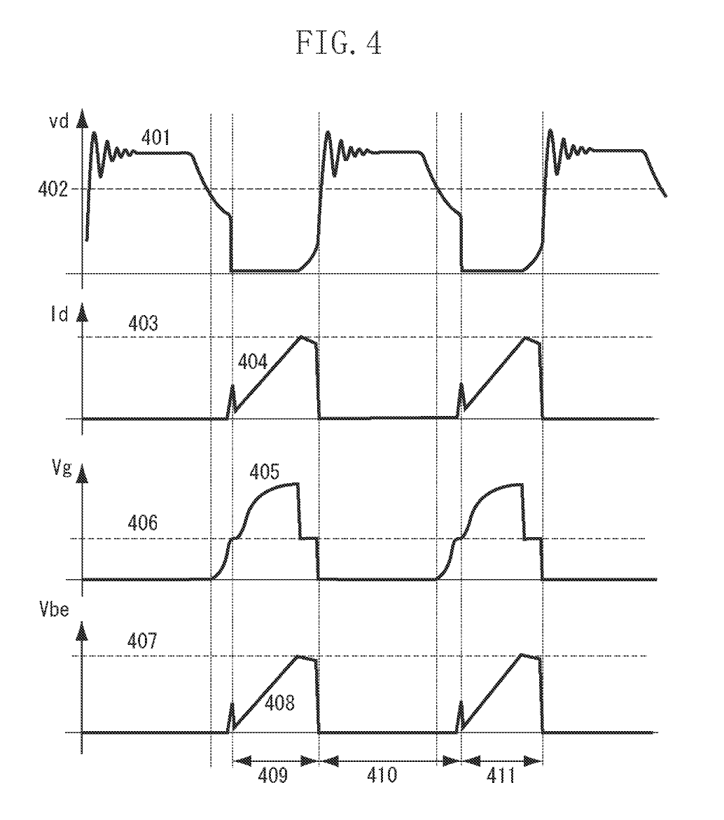

FIG. 3 illustrates operation waveforms of the circuit according to the present exemplary embodiment. FIG. 4 illustrates operation waveforms of the conventional circuit illustrated in FIG. 8.

FIG. 3 illustrates a drain voltage waveform 301 of the switching element 106, a voltage 302 of the electrolytic capacitor 103, a drain current Id waveform 303 of the switching element 106, a current limitation value 304 previously determined by the current detection resistor 120 and the transistor 118, a gate voltage waveform 305 of the switching element 106, a gate threshold voltage 306 of the switching element 106, a base voltage 307 of the transistor 118, and a base-to-emitter voltage 308 at which the transistor 118 is turned on. The switching element 106 is ON in periods 309 and 311, while being OFF in a period 310.

FIG. 4 illustrates a drain voltage waveform 401 of the switching element 804, a voltage 402 of the capacitor 801, a drain current Id waveform 403 of the switching element 804, and a current limitation value 404 previously determined by the current detection resistor 806 and the transistor 815, a gate voltage waveform 405 of the switching element 804, a gate threshold voltage 406 of the switching element 804, a base voltage 407 of the transistor 815, and a base-to-emitter voltage 408 at which the transistor 815 is turned on. The switching element 804 is ON in periods 409 and 411, while being OFF in a period 410.

In the conventional circuit, when the switching element 804 is turned off by current detection, i.e., at the time of transition from the period 409 to the period 410, the current does not rise, so that the voltage of a detection resistor does not rise. Therefore, the transistor 815 is not in a saturated state, so that the gate voltage of the switching element 804 remains.

Therefore, it is found that the period of time consumed to turn off the switching element 804 is lengthened. Simultaneously, the drain current 403 in the switching element 804 does not rise, so that the drain voltage of the switching element 804 starts to rise. The switching element 804 is turned off with the drain voltage being high.

On the other hand, in the circuit according to the present exemplary embodiment, the gate voltage of the switching element 106 is discharged by the self-holding circuit including the transistors 118 and 119. When the gate voltage starts to drop once, a discharge current for the gate voltage does not decrease due to a decrease in the drain current. It is found that the period of time consumed to turn off the switching element 106 is not lengthened. The self-holding circuit may be composed of a thyristor element. As described above, according to the present exemplary embodiment, it is possible to shorten the period of time consumed to turn off the switching element 106 to reduce the switching loss thereof.

A switching power supply apparatus of a self-excited oscillation type according to a second exemplary embodiment will be described. The second exemplary embodiment is an example of a circuit configured to perform a self-holding operation even when a time constant circuit turns a switching element off.

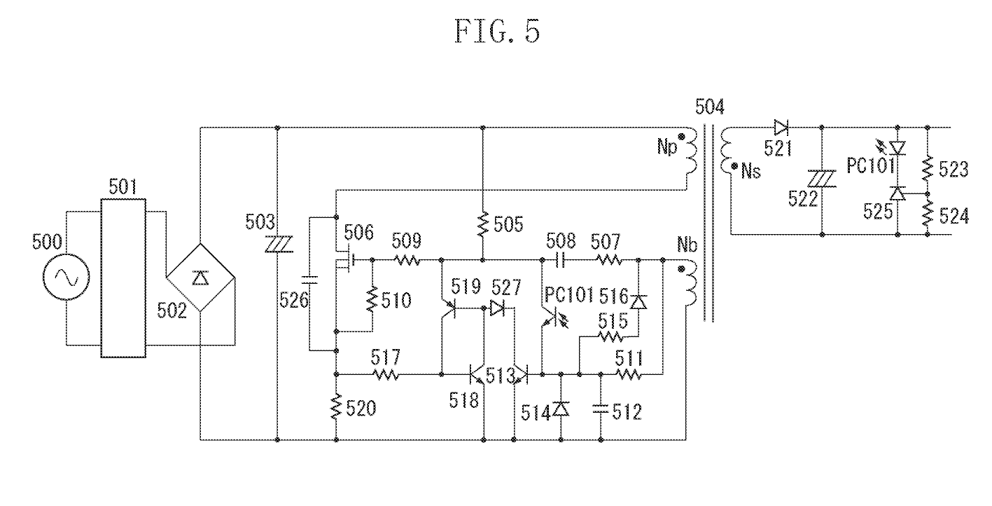

FIG. 5 is a circuit diagram of the switching power supply apparatus of the self-excited oscillation type according to the present exemplary embodiment. In FIG. 5, the switching power supply apparatus includes a commercial AC power source 500, a filter circuit 501, a diode bridge 502, a primary electrolytic capacitor 503, a switching transformer 504, a primary winding Np of the transformer 504, a secondary winding Ns of the transformer 504, a bias winding (feedback winding) Nb of the transformer 504, a start resistor 505, a switching element 506, resistors 507, 509, and 510, and a capacitor 508. The switching power supply apparatus further includes resistors 511, 515, 517, 520, 523, and 524, NPN transistors 513 and 518, a PNP transistor 519, a capacitor 512 and 526, diodes 514 and 516, a secondary rectifier diode 521, and an electrolytic capacitor 522, a shunt regulator 525.

Only units different from those in the first exemplary embodiment will be described and hence, the overlapped description is omitted. The transistor 113 in the circuit according to the first exemplary embodiment is changed to the transistor 513. The transistor 513 is connected to the base of the transistor 519 via a diode 527. The voltage of the current detection resistor 520 rises and the transistor 518 is operated, as in the first exemplary embodiment.

When the voltage of the capacitor 512 in a time constant circuit rises, and a base current flows through the base of the transistor 513 so that a collector current flows through the collector of the transistor 513, a base current flows through the base of the transistor 519 via the diode 527, and a collector current flows through the collector of the transistor 519.

Even if the transistor 513 is operated by a collector current in a phototransistor in a photocoupler PC101, the base current in the transistor 519 flows via the diode 527, and the collector current flows through the transistor 519. Since the collector current in the transistor 519 is supplied to the base of the transistor 518, the transistor 518 causes a collector current, which is Hfe2 times the base current, to flow. The transistor 518 has its collector connected to the base of the transistor 519. Therefore, the base current in the transistor 519 increases.

As described above, the transistors 518 and 519 perform a self-holding operation by the operation of the transistor 513, to discharge the charge on the gate of the switching element 516. Not only at the time when the voltage of the current detection resistor 520 rises but also in an OFF operation in a normal feedback operation, the self-holding operation can also be performed.

In the first exemplary embodiment, the period of time consumed to turn off the switching element 106 in consequence of the capacitor 112 and the resistor 111 in the time constant circuit depends on the current in the resistor 111, the collector current in the phototransistor in the photocoupler PC101, and the current gain Hfe of the transistor 113.

The voltage of the winding Nb of the transformer 104 drops as the switching element 106 is turned off. Therefore, the current in the resistor 111 and the collector circuit in the phototransistor in the photocoupler PC101 also decrease. As a result, the base current of the transistor 113 decreases, and accordingly the collector current thereof decreases, i.e., the time constant circuit is affected by negative feed back.

On the other hand, in the second exemplary embodiment, the time constant circuit is not easily affected by the negative feedback by being exerted on the self-holding circuit including the transistors 518 and 519. Therefore, a period of time consumed to turn off the switching element 506 can be made shorter.

Therefore, according to the second exemplary embodiment, it is possible to shorten the period of time consumed to turn off the switching element 506 to reduce the switching loss thereof. The self-holding circuit may include a thyristor element.

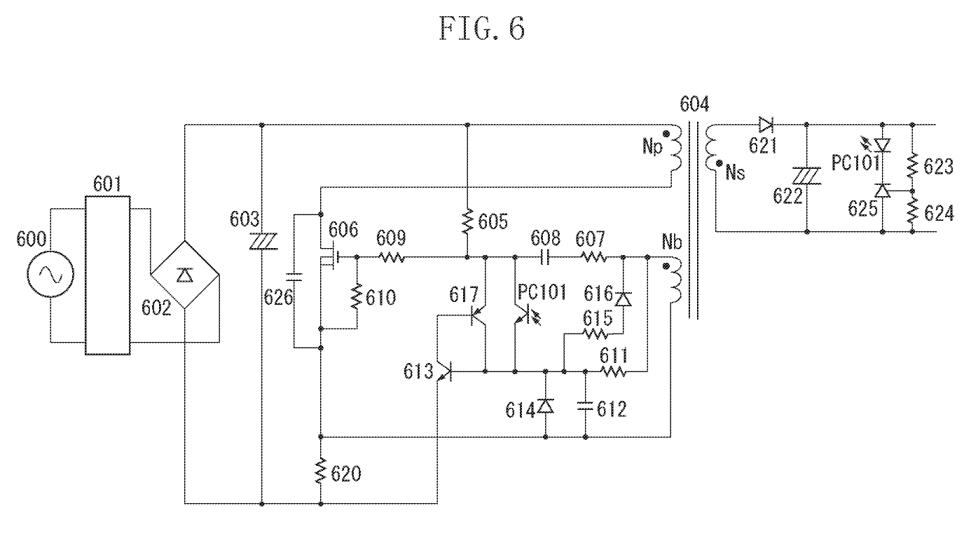

A switching power supply apparatus of a self-excited oscillation type according to a third exemplary embodiment will be described. The third exemplary embodiment is an example in which a transistor in a self-holding circuit is used as an ON-time control circuit. FIG. 6 is a circuit diagram of the switching power supply apparatus of the self-excited oscillation type according to the present exemplary embodiment. Only units according to the present exemplary embodiment will be described and hence, the overlapped description is omitted.

In FIG. 6, the switching power supply apparatus includes a commercial AC power source 600, a filter circuit 601, a diode bridge 602, a primary electrolytic capacitor 603, a switching transformer 604, a primary winding Np of the transformer 604, a secondary winding Ns of the transformer 604, and a bias winding (auxiliary winding) Nb of the transformer 604, a start resistor 605, a switching element 606, resistors 607, 609, and 610, a capacitor 608. The switching power supply apparatus further includes resistors 611, 615, 620,623, and 624, an NPN transistor 613, a PNP transistor 617, a capacitor 612 and 626, and diodes 614 and 616, a secondary rectifier diode 621, and an electrolytic capacitor 622, a shunt regulator 625. The transistors 613 and 617 constitute a self-holding circuit.

When a current flowing through the drain of the switching element 606 increases, and the voltage of the resistor 620 rises, an emitter voltage of the transistor 613 drops relative to a base voltage thereof. A current is supplied to the capacitor 612 in a time constant circuit from the winding Nb via the resistor 611. Therefore, a base-to-emitter voltage of the transistor 613 rises, so that a base current starts to flow through the base of the transistor 613.

The transistor 613 causes a collector current, which is Hfe1 times the base current, to flow. The collector current becomes abase current in the transistor 617. On the other hand, the collector of the transistor 617 supplies a current to the base of the transistor 613. Therefore, the transistor 613 causes more current to flow through the collector of the transistor 613, i.e., the base of the transistor 617.

The above-mentioned operations enable the transistors 613 and 617 to be maintained in an ON state irrespective of the voltage of the current detection resistor 620 when a detection voltage of the current detection resistor 620 reaches a defined value once, to discharge a gate voltage of the switching element 606.

The base-to-emitter voltage of the transistor 613 is the sum of the voltage of the current detection resistor 620 and the voltage of the capacitor 612 in the time constant circuit. Therefore, this circuit can be operated not only at the time when an excess current is detected but also at the time of a normal turn-off operation. More specifically, a circuit can be constituted by components whose number is smaller than in the second exemplary embodiment, and the current detection resistor 620 whose resistance value is lower can be used. This enables a loss due to resistance to be restrained, thereby enabling the efficiency to increase.

As described above, in the present exemplary embodiment, the number of components can be reduced while a self-holding operation can be performed even in operations other than the current detecting operation by using one transistor as both the transistor 118 for current detection and the ON-time control transistor 113. Therefore, the self-holding circuit may include a thyristor element.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-061110 filed Mar. 13, 2009, which is hereby incorporated by reference herein in its entirety.

What is claimed is:

1. A power supply apparatus comprising:
a transformer;
a switching unit configured to control a current flowing through a primary winding of the transformer;
a current detection unit configured to detect the current;
a voltage output unit connected to a secondary winding of the transformer;
an ON-time control unit connected to an auxiliary winding of the transformer and configured to control a period of time to turn on the switching unit; and
a current limitation unit configured to limit a current to flow to the switching unit based on the detected current,
wherein the current limitation unit has a self-holding unit configured to self-hold a state where the current to the switching unit is limited.

2. The power supply apparatus according to claim 1, wherein the ON-time control unit includes a time constant circuit, and the time constant circuit controls the period of time.

3. The power supply apparatus according to claim 1, wherein the current limitation unit limits the current to flow to the switching unit when the detected current exceeds a predetermined value.

4. The power supply apparatus according to claim 1, wherein the self-holding unit performs a self-holding operation when the ON-time control unit turns the switching unit off.

5. The power supply apparatus according to claim 1, wherein the self-holding unit includes a thyristor element.
